(19) United States
(12) Patent Application Publication
(10) Pub. No.: US 2019/0084545 A1
(43) Pub. Date: Mar. 21, 2019

(54) AIRLINE COUPLE

(71) Applicant: Wesley Williams, Gold Canyon, AZ (US)

(72) Inventor: Wesley Williams, Gold Canyon, AZ (US)

(21) Appl. No.: 15/479,298

(22) Filed: Apr. 5, 2017

(51) Int. Cl. B60T 17/04; F16L 13/10; F16L 19/00

(52) U.S. Cl. CPC B60T 17/043; F16L 19/00; F16L 13/103

(57) ABSTRACT

An airline couple that provide consumers a way to keep air lines connected while driving. The first airline couple includes a first airline connector extending forward, an airline clip including a planar rectangular tab that includes a pair of apertures disposed on the planar rectangular tab and a second airline connector extending back towards the airline clip, the airline clip is wrapped around the first airline connector and the second airline connector. The airline couple includes a piece of putty wrapped around each end of a first airline connector and a second airline connector, the piece of putty hardens between each end of the first airline connector and the second airline connector securing each end of the first airline connector and the second airline connector.

### BACKGROUND OF THE INVENTION

### Field of the Invention

The present invention is a couple. More specifically, the present invention is an airline couple.

### Description of the Related Art

Many trailer braking systems are usually found on utility and commercial trucks adjoining various towing vehicles/containers. Moreover, duct tape, binge straps, and/or zip ties are commonly used to secure these connections but are prone to breaking and snapping due to twists and turns.

What is needed is an airline couple that provide consumers a way to keep air lines connected while driving.

### SUMMARY OF THE INVENTION

The present invention is a couple. More specifically, the present invention is an airline couple.

The airline couple includes a first airline connector extending forward, an airline clip including a planar rectangular tab that includes a pair of apertures disposed on the planar rectangular tab and a second airline connector extending back towards the airline clip, the airline clip is wrapped around the first airline connector and the second airline connector.

A second couple includes a piece of putty wrapped around each end of a first airline connector and a second airline connector, the piece of putty hardens between each end of the first airline connector and the second airline connector securing each end of the first airline connector and the second airline connector.

It is an object of the present invention to provide an airline couple that provide consumers a way to keep air lines connected while driving.

It is an object of the present invention to provide an airline couple that clasp used to connect the service and emergency air lines from the truck or tractor to the trailer without the use of duct tape, zip ties and binge straps to meet any trucker's need.

It is an object of the present invention to provide an airline couple that is designed to be manufactured with plastic materials for use in any weather condition for optimal durability.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a first airline couple, in accordance with one embodiment of the present invention.

FIG. 2 illustrates a side view of a second airline couple, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

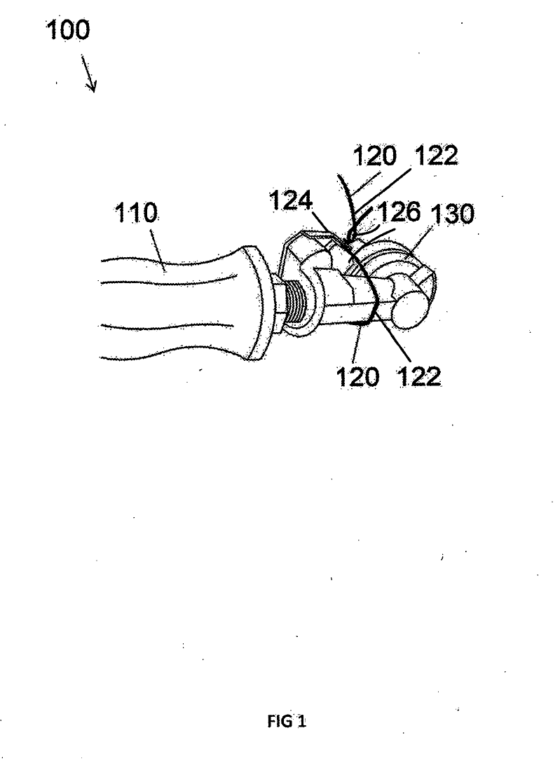

FIG. 1 illustrates a front view of an airline couple 100, in accordance with one embodiment of the present invention.

The airline couple 100 may include a first airline connector 110, an airline clip 120 and a second airline connector 130.

The first airline connector 110 may extend forward. The airline clip 120 may wrap around the airline connector 110. The airline clip 120 may be an elongated piece of wire 122 or another suitable elongated object. The airline clip 120 may include a planar rectangular tab 124 that includes a pair of apertures 126 disposed on the planar rectangular tab 124.

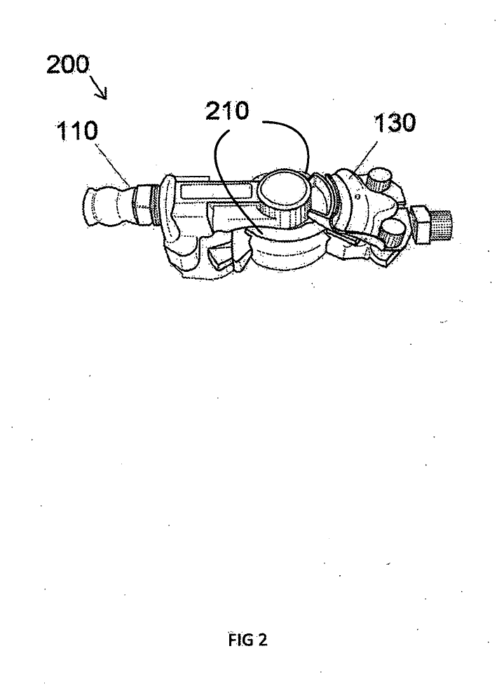

FIG. 2 illustrates a side view of a second airline couple 200, in accordance with one embodiment of the present invention.

The second airline couple 200 may be a piece of putty 210 that is wrapped around each end of the first airline connector 110 and the second airline connector 130. The piece of putty 210 may harden between each end of the first airline connector 110 and the second airline connector 130 securing each end of the first airline connector 110 and the second airline connector 130.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. An airline couple, comprising:
a first airline connector extending forward:
an airline clip including a planar rectangular tab that includes a pair of apertures disposed on the planar rectangular tab; and
a second airline connector extending back towards the airline clip, the airline clip is wrapped around the first airline connector and the second airline connector.

2. The airline couple per claim 1, wherein the airline clip is an elongated piece of wire.

3. (canceled)

4. The airline couple per claim 1*, wherein each end of the first airline connector and the second airline connector are adapted to extend through the pair of apertures.

5. An airline couple, comprising: a piece of putty wrapped around each end of a first airline connector and a second airline connector, the piece of putty hardens between each end of the first airline connector and the second airline connector securing each end of the first airline connector and the second airline connector.
